(19) United States
(12) Patent Application Publication
(10) Pub. No.: US 2014/0263782 A1
(43) Pub. Date: Sep. 18, 2014

(54) PAPER SHREDDER WITH OUTPUT DEFLECTOR

(71) Applicant: ACCO BRANDS CORPORATION, Lincolnshire, IL (US)

(72) Inventor: Benjamin T. Thurnell, Buckingham (GB)

(73) Assignee: ACCO BRANDS CORPORATION, Lincolnshire, IL (US)

(21) Appl. No.: 13/800,360

(22) Filed: Mar. 13, 2013

(51) Int. Cl. B02C 18/22; B02C 18/00

(52) U.S. Cl. CPC B02C 18/2216; B02C 18/0007
USPC 241/100

(57) ABSTRACT

A paper shredder includes a housing, a rotatable shredding assembly, a bin, and a flap. The housing defines a first end with a housing opening and a second end opposite the first end. The shredding assembly is positioned in the housing and has a lower wall including an output opening through which shredded scraps exit the shredding assembly. The output opening has first and second sides, and the first side is closer to the housing opening than the second side. The bin is insertable into the housing through the housing opening for collecting the shredded scraps exiting the shredding assembly, and is removable from the housing in a removal direction from the second end toward the first end. The deflector is positioned adjacent the second side of the output opening, and extends in the removal direction to cover part of the output opening to facilitate deflecting one part of the shredded scraps off of the deflector in the removal direction while allowing another part of the shredded scraps to exit in a substantially unimpeded manner.

### BACKGROUND

The present invention generally relates to the field of paper shredders, and specifically to paper shredders that have a bin or receptacle for collecting shredded paper scraps.

Paper shredders are commonly used to shred documents in order to preserve the confidentiality of the information on the documents. Shredders come in a variety of sizes, from large industrial shredders capable of shredding stacks of sheets of paper at one time, to personal and office shredders that can shred up to several sheets at one time.

Some personal and office shredders are designed to have paper hand fed into the shredder. These shredders include a slot, typically on the top of the shredder, and sheets of paper are fed into the slot. Other shredders are designed to accommodate a stack of paper for shredding. These shredders commonly pull sheets of paper from the stack for shredding several sheets at a time.

Both types of shredders often include a bin for collecting and storing shredded paper scraps. Such bins are typically removably received beneath the shredding mechanism so that, when filled with shredded scraps, the bin can be separated from the shredding mechanism and emptied by a user into a trash receptacle. The emptied bin can then be repositioned beneath the shredding mechanism to be filled again upon continued shredding.

### SUMMARY OF THE INVENTION

In one aspect, the present invention provides a paper shredder including a housing, a shredding assembly, a bin, and a deflector. The housing defines a first end with a housing opening and a second end opposite the first end. The shredding assembly is positioned in the housing and has a lower wall including an output opening through which shredded scraps exit the shredding assembly. The output opening has first and second sides, and the first side is closer to the housing opening than the second side. The bin is insertable into the housing through the housing opening for collecting the shredded scraps exiting the shredding assembly, and is removable from the housing in a removal direction from the second end toward the first end. The deflector is positioned adjacent the second side of the output opening, and extends in the removal direction to cover part of the output opening to facilitate deflecting one part of the shredded scraps off of the deflector in the removal direction while allowing another part of the shredded scraps to exit in a substantially unimpeded manner.

In another aspect, the present invention provides a housing, a shredding assembly, a bin, and a deflector. The housing defines a first end with a housing opening and a second end opposite the first end. The shredding assembly is positioned in the housing and has a pair of cutters and a lower wall including an output opening through which shredded scraps exit the shredding assembly. The pair of cutters defines a medial plane extending therebetween. The output opening has first and second sides, and the first side is closer to the housing opening than the second side. The output opening defines a width extending substantially perpendicular to the medial plane, and an output opening area. The bin is insertable into the housing through the housing opening for collecting the shredded scraps exiting the shredding assembly, and is removable from the housing in a removal direction from the second end toward the first end. The deflector is positioned adjacent the second side of the output opening, and extends in the removal direction along a cover length. The cover length is approximately 5% to approximately 45% of the width. The deflector covers approximately 5% to approximately 45% of the output opening area.

Other aspects of the invention will become apparent by consideration of the detailed description and accompanying drawings.

### BRIEF DESCRIPTION OF THE DRAWINGS

FIG. 1 is a perspective view, shown partially in section, of a paper shredder according to an embodiment of the present invention.

FIG. 2 is a partially exploded view of the shredder of FIG. 1, illustrating the bin removed from the housing.

FIG. 3 is a partial end view of the shredder of FIG. 1, illustrating the bin removed from the housing.

FIG. 4 is a bottom view of the shredder of FIG. 1.

FIG. 5 is a partial sectional view of the shredder of FIG. 1, illustrating the deflector.

FIG. 6 is a schematic sectional view of the shredder of FIG. 1, illustrating the bin as being partially removed, with the deflector positioned above the bin.

FIG. 7 is a schematic sectional view similar to FIG. 6, illustrating the bin as being further removed, with the deflector positioned outside the bin.

FIG. 8 is a schematic sectional view similar to FIG. 6, illustrating the bin as being fully removed.

FIG. 9 is an exploded perspective view of a paper shredder according to another embodiment of the invention.

FIG. 10 is an exploded end view of the shredder of FIG. 9.

FIG. 11 is a sectional perspective view taken long line 11-11 of FIG. 9.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Referring to FIGS. 1 and 2, the illustrated shredder 10 includes a housing 20, a bin 30 removably positioned in the housing 20, a shredding assembly 40 mounted or positioned in the housing 20, and a feeder assembly 50 pivotally mounted to the housing 20. By pivoting the feeder assembly 50 upward, a stack of paper (not shown) can be placed on a feeder base in preparation for shredding. The feeder assembly 50 is then closed, and the shredding operation is performed by pulling bottom sheets of the stack of paper through the feeder base and into the shredding assembly 40. The paper passes through a pair of rotary cutters 60 of the shredding assembly 40, which shred the paper and drop it into a waste area where the bin or receptacle 30 is positioned. The illustrated shredder 10 is an auto-feed type shredder and is further described in detail in U.S. Pat. No. 8,336,794, which is incorporated by reference herein. Alternatively, the present invention can be practiced with manual-feed type shredders that include a bin to collect the shredded scraps.

Referring also to FIG. 2, the housing 20 defines a first end 70 with a housing opening 80, a second end 90 opposite the first end 70, and a cavity 100 in which the bin 30 is removably received. The illustrated cavity 100 is defined in part by a base or floor 110, first and second side walls 120, 130 extending upwardly from the floor 110, and a rear wall 140 extending upwardly from the floor 110 between the side walls 120, 130. As used herein and in the appended claims, the terms “floor,” “side,” “rear,” “front,” “upper,” “lower,” and other such terms are used to describe the illustrated orientation, but are not intended to be limiting to the illustrated orientation. The bin 30 is insertable into the housing 20 through the housing opening 80 for collecting shredded paper scraps or chips exiting the shredding assembly 40. After shredding is completed, the bin 30 can be slid out of the housing opening 80 for disposal, in a removal direction 150 from the second end 90 toward the first end 70. Although FIG. 2 illustrates the housing opening 80 as being positioned at a front or forward end of the housing 20, in other embodiments, the housing opening 80 may be positioned at the sides or rear of the housing 20. In some embodiments, a door of the housing 20 could be opened to provide access to the removable bin 30 (i.e., a cabinet-style shredder).

The illustrated shredding assembly 40 has a lower wall 160 including an output opening 170 through which the shredded scraps exit the shredding assembly 40. The output opening 170 has first and second sides 172, 174. The first side 172 is closer to the housing opening 80 than the second side 174, and the second side 174 is closer to the second end 90 than the first side 172. An output deflector 180 is positioned adjacent the second side 174 of the output opening 170. As explained below, the output deflector 180 can facilitate deflecting one part of the shredded scraps in the removal direction 150 while allowing another part of the shredded scraps to exit in a substantially unimpeded manner. Although the illustrated deflector 180 is a substantially unitary member, in other embodiments the deflector 180 can be made up of one or more portions or pieces. Each of the housing 20, the bin 30, and the deflector 180 can be molded or formed from any suitable plastic, or can be made in other manners from other materials.

During use of the shredder 10, shredded scraps may fall out of the bin 30 and collect on the floor 110. This may occur as the bin 30 gets filled and/or during removal of the bin 30 from the cavity 100. In other instances, the shredded scraps may simply fall between the walls of the bin 30 and the walls 120, 130, 140. Furthermore, residual shredded scraps hanging from the shredding assembly 40 may fall to the floor 110 after the user has removed the bin 30 to dispose of the collected scraps. In those or other cases in which shredded scraps may come to rest on the floor 110, it has previously been time consuming and difficult to remove the scraps from the floor 110 in order to rid the cavity 100 of shredded scraps.

In the illustrated embodiment, the deflector 180 extends in the removal direction 150 to cover part of the output opening 170 to facilitate deflecting one part of the shredded scraps off of the deflector 180 in the removal direction 150 while allowing another part of the shredded scraps to exit in a substantially unimpeded manner. When the bin 30 is substantially empty, and shredding begins, one portion of the shredded scraps may come into contact with the deflector 180 while another portion of the shredded scraps may fall into the bin 30 substantially unimpeded. As to the shredded scraps that come into contact with the deflector 180, the deflector 180 directs the shredded scraps toward a forward portion of the bin 30. As the bin 30 fills, continued shredding may lead to a tangle or stack of scraps building up to or near the output opening 170 and/or deflector 180. In addition to directing the shredded scraps toward the forward portion of the bin 30, the deflector 180 then squashes or compacts a portion of the shredded scraps exiting the shredding assembly 40, while allowing another portion of the shredded scraps to fall substantially unimpeded toward the bin 30. The squashing or compacting of the shredded scraps can aid in further directing or pushing the collected scraps toward the forward portion for the bin 30. Without squashing or compacting the shredded scraps, the bin 30 could be quickly filled, and once the bin 30 is full, the shredded scraps could fall over the bin 30 and onto the floor 110 of the housing 20, especially upon removal of the bin 30. In contrast, the deflector 180 facilitates the shredded scraps falling into the bin 30 in a clean and tidy manner.

Referring to FIG. 3, the deflector 180 is exposed to view from the first end 70 when the bin 30 is removed from the housing opening 80. In other embodiments, however, the deflector 180 may be obstructed from view in whole or in part when the bin 30 is removed from the housing opening 80. Also referring to FIG. 4, the illustrated pair of cutters 60 defines a medial plane 190 extending therebetween, and the output opening 170 defines a width W in the removal direction 150 extending substantially perpendicular to the medial plane 190. In some embodiments, the width W can range from approximately 5 mm to approximately 200 mm, or from approximately 40 mm to approximately 50 mm. The deflector 180 extends over the output opening 170 along a cover length L in the removal direction 150. In some embodiments, the cover length L is approximately 10 mm, or approximately 15% to approximately 25% of the width W. In further embodiments, the cover length L is approximately 5% to approximately 45% of the width W. In other embodiments, the deflector 180 may cover other percentages of the output opening 170 to suitably facilitate deflecting one part of the shredded scraps in the removal direction 150 while allowing another part of the shredded scraps to exit in a substantially unimpeded manner.

In the illustrated embodiment, the output opening 170 defines a lateral dimension D and the deflector 180 is substantially centered relative to the lateral dimension D. In other embodiments, however, the deflector 180 may be positioned off-center relative to the lateral dimension D. In some embodiments, the lateral dimension D ranges from approximately 200 mm to approximately 250 mm, and the deflector 180 extends along a length of approximately 150 mm to approximately 160 mm, or approximately 60% to approximately 100% of the lateral dimension D. In some embodiments, the deflector 180 extends along a length of approximately two thirds of the lateral dimension D. In other embodiments, the deflector 180 may extend along a length of other percentages of the lateral dimension D to suitably facilitate deflecting one part of the shredded scraps in the removal direction 150 while allowing another part of the shredded scraps to exit in a substantially unimpeded manner.

In the illustrated embodiment, the output opening 170 defines an output opening area of approximately 110 cm² from a bottom view. The illustrated deflector 180 covers approximately 15 cm², or approximately 10% to approximately 15% of the output opening area. In some embodiments, the deflector 180 may cover 5% to approximately 45% of the output opening area. In other embodiments, the deflector 180 may cover other percentages of the output opening area to suitably facilitate deflecting one part of the shredded scraps in the removal direction 150 while allowing another part of the shredded scraps to exit in a substantially unimpeded manner.

Referring also to FIG. 5, the illustrated deflector 180 extends toward the removal direction 150 at an angle θ of approximately 45 degrees to approximately 75 degrees relative to the lower wall 160, and in the illustrated embodiment is approximately 60 degrees. The angle θ of the deflector 180 can facilitate directing the shredded scraps in the removal direction 150. Moreover, the angle θ of the deflector 180 can enhance the fill capacity of the bin 30. As the bin 30 fills, the shredded scraps tend to decompress or spring back and tangle on an underside of the shredding assembly 40. The angle θ of the deflector 180 facilitates squashing and reducing the length of the shredded scraps, thus allowing more shredded scraps to fill into the bin 30.

In some embodiments, the deflector 180 is pivotally mounted relative to the lower wall 160 and is further operable as a flap for detecting when the bin 30 is full of shredded scraps. For example, the deflector 180 can be biased toward the angle θ by a resilient member (not shown). In other embodiments, however, the deflector 180 is not necessarily pivotable relative to the lower wall 160, and rather fixedly mounted to the lower wall 160, extending at the angle θ.

Referring to FIG. 6, in operation, as the bin 30 fills, the shredded scraps tend to decompress or spring back and tangle on an underside of the shredding assembly 40. When the deflector 180 is positioned above the bin 30, the deflector 180 directs a first shredded scrap portion 200 (e.g., a tangle or stack of scraps) toward a forward portion of the bin 30 (i.e., to the left in FIG. 6), and leaves a free or empty space or void 210 in the rear of the bin 30 (i.e., to the right in FIG. 6). Additionally, by virtue of its size and configuration, the illustrated deflector 180 squashes or compacts only a portion of the shredded scraps exiting the shredding assembly 40. Depending on the use requirements or preferences for the particular shredder 10, compacting all of the shredded scraps may be undesirable, because the shredder 10 may use more energy, thus over-heating faster. Moreover, continuous and/or complete compaction of shredded scraps could easily clog or jam up the shredder 10, potentially causing issues with the paper feeding system. In contrast, the illustrated deflector 180 can squash or compact only a portion of the shredded scraps and can direct a portion of the shredded scraps toward a forward portion of the bin 30 while allowing another portion of the shredded scraps to fall substantially unimpeded toward the bin 30.

When a full bin 30 is detected, the user can reverse the shredding assembly 40, e.g., manually or automatically, for a predetermined time (e.g, up to approximately 50 seconds) and/or a predetermined sequence, to break a second or residual shredded scrap portion 220 that is hanging from the shredding assembly 40 over the bin 30. Subsequently, as the bin 30 is being removed from the housing opening 80 and the deflector 180 is positioned outside the bin 30 (see FIG. 7), the second shredded scrap portion 220 may move or drop into the space 210 at the rear of the bin 30, e.g., via gravity and/or inertia.

In some embodiments, the shredder 10 optionally includes a paper level plate 230 (see FIGS. 6-8) adjacent the output opening 170 at a location closer to the first end 70 than to the second end 90. The paper level plate 230 may drag the second shredded scrap portion 220 or otherwise push or level collected scraps into the space 210 at the rear of the bin 30 as the bin 30 is removed from the housing opening 80. Therefore, the paper level plate 230 may aid an even spread of shredded scraps across the bin 30. In other embodiments, however, the shredder 10 may not include the paper level plate 230, and the second shredded scrap portion 220 may simply move or drop into the space 210 at the rear of the bin 30, e.g., via gravity and/or inertia.

Referring also to FIG. 8, when the bin 30 is fully removed from the housing opening 80, the second shredded scrap portion 220 is moved into the space 210 at the rear of the bin 30. The shredded scrap portions 200, 220 can thus evenly fill into the bin 30. Without the space 210 created by the deflector 180, scraps could fall over the rear wall out of the bin 30 and onto the floor 110 of the housing 20. Therefore, the illustrated shredder 10 reduces the amount of shredded scraps falling out of the bin 30, and as such can be operated in a clean and tidy manner. Furthermore, user intervention to clean the shredder after removing the bin 30 can be reduced.

In some embodiments, the deflector 180 may be positioned adjacent the first side 172 of the output opening 170, and extend in a direction substantially opposite the removal direction 150. The deflector 180 may thus facilitate deflecting one part of the shredded scraps off of the deflector in a direction substantially opposite the removal direction 150 while allowing another part of the shredded scraps to exit in a substantially unimpeded manner. When the bin 30 is substantially empty, and shredding begins, one portion of the shredded scraps may come into contact with the deflector 180 while another portion of the shredded scraps may fall into the bin 30 substantially unimpeded. As to the shredded scraps that come into contact with the deflector 180, the deflector 180 may direct the shredded scraps toward a rearward portion of the bin 30, and leave a free or empty space or void in the front. Subsequently, as the bin 30 is being removed from the housing opening 80, a portion of the shredded scraps may move or drop into the free space, e.g., via gravity and/or inertia.

FIGS. 9-11 illustrate the shredder 10′ according to another embodiment of the invention. Structure and features of the embodiment shown in FIGS. 9-11 that correspond to structure and features of the embodiment of FIGS. 1-8 are designated hereinafter with like reference numbers. The shredder 10′ in this embodiment includes a lift-off head 20′ that is removably coupled to the bin 30′. When coupled together, the lift-off head 20′ is positioned substantially above the bin 30′. The shredder 10′ uses a manual feed mechanism to deliver material directly to the shredding assembly 40 as manually inserted by a user. When a full bin 30′ is detected, the user removes the head 20′ by lifting or raising the head 20′ off of the bin 30′ toward a removal direction 150′, and the user can then move the bin 30′ to dispose of the collected scraps.

In the illustrated embodiment, the deflector 180′ extends substantially opposite the removal direction 150′ of the lift-off head 20′. Otherwise, the same characteristics described above regarding the size and configuration of the deflector 180′, and its relationships to the output opening 170′, apply equally to the shredder 10′. When the bin 30′ is substantially empty, and shredding begins, one portion of the shredded scraps may come into contact with the deflector while another portion of the shredded scraps may fall into the bin 30′ substantially unimpeded. As to the shredded scraps that come into contact with the deflector 180′, the deflector 180′ directs the shredded scraps toward a forward portion of the bin 30′, and leaves a free or empty space or void in the rear. Subsequently, as the lift-off head 20′ is being removed from the bin 30′, a portion of the shredded scraps may move or drop into the free space, e.g., via gravity. As detailed above in connection the embodiment shown in FIGS. 1-8, without the space created by the deflector 180′, scraps could fall out of the bin 30′ and onto a support surface such as the floor. The illustrated shredder 10′ reduces the amount of shredded scraps falling out of the bin 30′, and as such can be operated in a clean and tidy manner. Furthermore, user intervention to clean the shredder 10′, or the surrounding area, after removing the lift-off head 20′ can be reduced.

Various features of the invention are set forth in the following claims.

What is claimed is:

1. A paper shredder comprising:
a housing defining a first end with a housing opening and a second end opposite the first end;
a shredding assembly positioned in the housing, the shredding assembly having a lower wall including an output opening through which shredded scraps exit the shredding assembly, the output opening having first and second sides, the first side being closer to the housing opening than the second side;
a bin insertable into the housing through the housing opening for collecting the shredded scraps exiting the shredding assembly, wherein the bin is removable from the housing in a removal direction from the second end toward the first end; and
a deflector positioned adjacent the second side of the output opening, the deflector extending in the removal direction to cover part of the output opening to facilitate deflecting one part of the shredded scraps off of the deflector in the removal direction while allowing another part of the shredded scraps to exit in a substantially unimpeded manner.

2. The paper shredder of claim 1, wherein the output opening defines an output opening area, and wherein the deflector covers approximately 5% to approximately 45% of the output opening area.

3. The paper shredder of claim 2, wherein the deflector covers approximately 10% to approximately 15% of the output opening area.

4. The paper shredder of claim 1, wherein the shredding assembly includes a pair of cutters and a medial plane extending therebetween, wherein the output opening defines a width in the removal direction extending substantially perpendicular to the medial plane, wherein the deflector extends over the output opening along a cover length in the removal direction, and wherein the cover length is approximately 5% to approximately 45% of the width.

5. The paper shredder of claim 4, wherein the cover length is approximately 15% to approximately 25% of the width.

6. The paper shredder of claim 1, wherein the deflector extends toward the removal direction at an angle of approximately 45 degrees to approximately 75 degrees relative to the lower wall.

7. The paper shredder of claim 1, wherein the deflector is pivotally mounted relative to the lower wall and is further operable as a flap for detecting when the bin is full of shredded scraps.

8. The paper shredder of claim 1, wherein the output opening defines a lateral dimension and wherein the deflector is substantially centered relative to the lateral dimension.

9. The paper shredder of claim 9, wherein the deflector extends along a length of approximately 60% to approximately 100% of the lateral dimension.

10. The paper shredder of claim 10, wherein the deflector extends along a length of approximately two thirds of the lateral dimension.

11. The paper shredder of claim 1, wherein the deflector is exposed to view from the first end when the bin is removed from the housing opening.

12. The paper shredder of claim 1, wherein the deflector is made of molded plastic.

13. The paper shredder of claim 1, wherein each of the housing, the bin, and the deflector is made of molded plastic.

14. A paper shredder comprising:
a housing defining a first end with a housing opening and a second end opposite the first end;
a shredding assembly positioned in the housing, the shredding assembly having a pair of cutters and a lower wall including an output opening through which shredded scraps exit the shredding assembly, the pair of cutters defining a medial plane extending therebetween, and the output opening having first and second sides, the first side being closer to the housing opening than the second side, and the output opening defining a width extending substantially perpendicular to the medial plane, and an output opening area;
a bin insertable into the housing through the housing opening for collecting the shredded scraps exiting the shredding assembly, wherein the bin is removable from the housing in a removal direction from the second end toward the first end; and
a deflector positioned adjacent the second side of the output opening, the deflector extending in the removal direction along a cover length, wherein the cover length is approximately 5% to approximately 45% of the width, and wherein the deflector covers approximately 5% to approximately 45% of the output opening area.

15. The paper shredder of claim 14, wherein the deflector covers approximately 10% to approximately 15% of the output opening area.

16. The paper shredder of claim 14, wherein the cover length is approximately 15% to approximately 25% of the width.

17. The paper shredder of claim 14, wherein the deflector extends toward the removal direction at an angle of approximately 45 degrees to approximately 75 degrees relative to the lower wall.

18. The paper shredder of claim 14, wherein the deflector is pivotally mounted relative to the lower wall and is further operable as flap for detecting when the bin is full of shredded scraps.

19. The paper shredder of claim 14, wherein the output opening defines a lateral dimension and wherein the deflector extends along a length of approximately two thirds of the lateral dimension.

20. The paper shredder of claim 14, wherein the deflector is exposed to view from the first end when the bin is removed from the housing opening.
